(19) United States
(12) Patent Application Publication
(10) Pub. No.: US 2025/0167609 A1
(43) Pub. Date: May 22, 2025

(54) MECHANICAL RETENTION OF ROTOR MAGNETS

(71) Applicant: Atieva, Inc., Newark, CA (US)

(72) Inventors: Yash NAGDA, Newark, CA (US); Ned HONG, Newark, CA (US)

(21) Appl. No.: 18/511,864

(22) Filed: Nov. 16, 2023

(51) Int. Cl. H02K 1/276; H02K 15/03

(52) U.S. Cl. CPC H02K 1/276; H02K 15/03

(57) ABSTRACT

A rotor for an electric machine includes a plurality of layers and magnets. The plurality of layers form a stack of layers with each layer defining a plurality of magnet openings therethrough. The plurality of magnet openings align to form a plurality of magnet channels that extend through the rotor. Each magnet opening is defined by an inner radial wall and an outer radial wall. The inner radial wall of at least one of the magnet openings of each layer includes an inner retention tab that extends towards the respective outer radial wall. Each magnet is received in a respective magnet channel and engaged with the inner retention tabs of multiple layers such that the magnet is mechanically retained in the respective magnet channel.

### TECHNICAL FIELD

Embodiments disclosed herein relate to electric machines. More specifically, embodiments disclosed herein relate to mechanical retention of rotor magnets for permanent magnet electric machines.

### BACKGROUND

In a permanent magnet AC motor, alternating current (AC) electrical power energizes windings of a stator to create a rotating magnetic field. This rotating magnetic field can be referred to as a stator flux. The stator flux can interact with a rotor flux generated in the rotor by permanent magnets retained on or within the surface of the rotor. The interaction of the stator flux with the rotor flux can generate an electromotive force to rotate a rotor shaft coupled to the rotor.

### SUMMARY

In an embodiment of the present disclosure, a rotor for an electric machine includes a plurality of layers and magnets. The plurality of layers form a stack of layers with each layer defining a plurality of magnet openings therethrough. The plurality of magnet openings align to form a plurality of magnet channels that extend through the rotor. Each magnet opening is defined by an inner radial wall and an outer radial wall. The inner radial wall of at least one of the magnet openings of each layer includes an inner retention tab that extends towards the respective outer radial wall. Each magnet is received in a respective magnet channel and engaged with the inner retention tabs of multiple layers such that the magnet is mechanically retained in the respective magnet channel.

In embodiments, one or more of the inner radial walls or the outer radial walls include a magnet stop that extends towards the opposite wall. The magnet stop may be configured to prevent a magnet passing through the magnet opening from translating within the magnet opening. An air channel of the magnet channel may be disposed beyond the magnet stops when the magnet is received in the magnet channel.

In some embodiments, the outer radial wall of at least one magnet opening of the plurality of magnet openings of each layer includes an outer retention tab that extends towards the respective inner radial wall. The outer retention tab may be configured to engage a magnet that passes through the magnet opening to mechanically retain the magnet in a respective magnet channel.

In certain embodiments, the inner retention tab extends from a point inner of the respective inner radial wall with a relief opening defined on either side of the inner tab. The magnet may be engaged with the inner radial walls defining the respective magnet channel.

In particular embodiments, each layer of the plurality of layer includes the inner retention tab in magnet opening adjacent a single pole of the respective layer. The remaining magnet openings of the respective layer of the plurality of layers define tab recess that are configured to receive the inner retention tab of other layers. Each layer of the plurality of layers is rotated by one or more poles or a pair of magnet openings from the previous layer such that the inner retention tabs are aligned at a predetermined number of layers. The predetermined number of layers being a function of the number of poles of the rotor or the number of poles of the rotor.

In embodiments, an electric machine includes a stator that defines a rotor cavity and a rotor as detailed herein rotatably disposed within the rotor cavity of the stator.

In another embodiment of the present disclosure, a rotor for an electric machine includes a plurality of layers that form a stack of layers and a magnet received in a respective magnet channel. Each layer of the stack of layers defines a plurality of magnet openings that are disposed radially about the respective layer. The magnet openings of each layer align with magnet opening of the other layers of the plurality of layers to define a plurality of magnet channels that extend through the rotor. Each magnet opening is defined by an inner radial wall and an outer radial wall that is opposite the inner radial wall. The plurality of magnet openings include a first magnet opening. The inner radial wall of the first magnet opening includes a retention tab that extends towards the outer radial wall. The magnet engages retention tabs of respective layers such that the magnet is mechanically retained in the respective magnet channel.

In embodiments, the plurality of layers include a first layer, a second layer in contact with the first layer, and a third layer in contact with the second layer such that the second layer is disposed between the first layer and the third layer. The first magnet opening of the first layer may be disposed adjacent a first magnetic pole of the rotor, the first magnet opening of the second layer may be disposed adjacent a second magnetic pole of the rotor, and the first magnet opening of the third layer may be disposed adjacent a third magnetic pole of the rotor. The first, second, and third magnetic poles may be disposed radially about the rotor from one another.

In certain embodiments, the plurality of layers includes a first layer, a second layer in contact with the first layer, and a third layer in contact with the second layer such that the second layer is disposed between the first layer and the third layer. The second layer rotated relative to the first layer such that the first magnet opening of the second layer is out of alignment with the first magnet opening of the first layer. The third layer is rotated relative to the second layer such that the first magnet opening of the third layers is out of alignment with the first magnet opening of the first layer and the first magnet opening of the second layer.

In some embodiments, engagement of the retention tabs of the respective layer with the magnet bends the retention tabs of the respective layers out of plane with the rest of the respective layer of the retention tab. The retention tabs may be self-biased towards the plane of the respective layer of the respective retention tab when engaged with the magnet. The retention tabs may be prebent out of plane with the rest of the respective layer of the respective retention tab.

In particular embodiments, each layer of the plurality of layers has a thickens in a range of 0.1 millimeters to 2.0 millimeters. The magnet may be in contact with the inner radial wall or the outer radial wall of the plurality of layers that define the respective magnet channel.

In another embodiment of the present disclosure, a method of manufacturing a rotor for an electric machine includes forming a plurality of layers with each layer defining a plurality of magnet openings that are disposed about the respective layer. The plurality of magnet opening includes a first magnet opening that includes a retention tab that extends into the magnet opening. The method includes stacking the plurality of layers with each layer rotated relative to the previous layer such that the first magnet opening is rotationally offset from the first magnet opening of the previous layer. The method includes inserting a magnet into a magnet channel that is defined by magnet openings of the plurality of layers such that the magnet is mechanically fixed in the magnet channel by engagement of the magnet with the retention tabs.

In embodiments, the method include prebending the retention tab such that the retention tab is out of plane with the rest of the respective layer before inserting the magnet into the magnet channel. Prebending the retention tab may include inserting a bar through the first magnet opening to prebend the retention tab such that the retention tab is out of plane with the rest of the respective layer before inserting the magnet into the magnet channel.

Further, to the extent consistent, any of the embodiments or aspects described herein may be used in conjunction with any or all of the other embodiments or aspects described herein.

### BRIEF DESCRIPTION OF THE DRAWINGS

The appended drawings illustrate examples and are, therefore, example embodiments and not considered to be limiting in scope. Various aspects of the present disclosure are described hereinbelow with reference to the drawings, which are not necessarily drawn to scale, which are incorporated in and constitute a part of this specification, wherein:

FIG. 1 is a perspective view of an electric machine provided in accordance with the present disclosure having a stator, a rotor, and a rotor shaft;

FIG. 2 illustrates a rotor of the electric machine of FIG. 1;

FIG. 3 illustrates a single layer of the rotor of FIG. 2;

FIG. 4 is an enlargement of a portion of the layer of FIG. 3;

FIG. 5 is a top view of a portion of the rotor of FIG. 2;

FIG. 6 is a cutaway view of a portion of the rotor of FIG. 2 before insertion of a magnet;

FIG. 7 is a cutaway view of the portion of the rotor of FIG. 6 with the magnet retained within a magnet opening of the rotor;

FIG. 8 is a flowchart of a method of manufacturing a rotor in accordance with the present disclosure; and

FIG. 9 is front view of another rotor provided in accordance with the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing tolerance or engineering considerations or the like.

As used herein, the term “electric machine” may refer to an electric motor that uses an electromotive force to rotate a rotor shaft that passes through the rotor or may refer to an electric generator that uses rotation of the rotor shaft to generate electric energy. An electric machine may be both an electric motor and an electric generator.

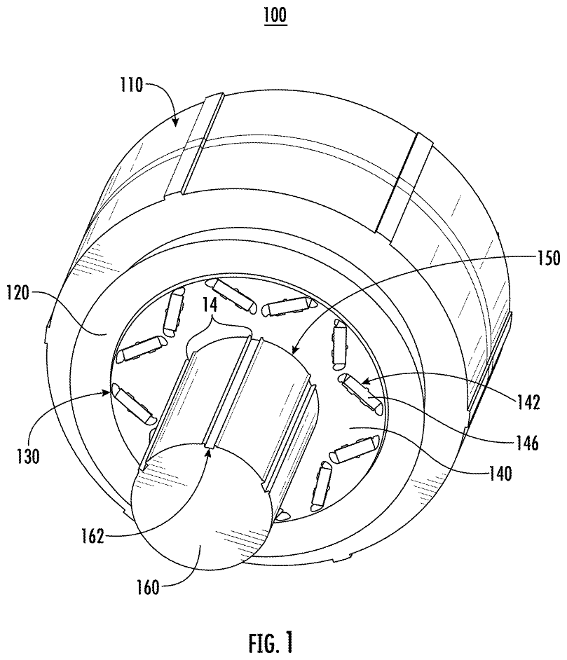

FIG. 1 illustrates an embodiment of an electric machine 100 provided in accordance with the present disclosure. The electric machine 100 includes a stator 120 and a rotor 140. In some embodiments, the stator 120 is disposed within a housing. The housing may protect portions of the stator 120 and or connections to the stator 120. The stator 120 may be formed of a plurality of layers or laminations (not explicitly shown) that are stacked with one another to form the stator 120. The stator 120 defines a rotor cavity (not explicitly shown) and is configured to generator a stator flux within the rotor cavity. The stator 120 may include a plurality of windings to generate the stator flux within the rotor cavity.

The rotor 140 is received within the rotor cavity and is configured to rotate about the central longitudinal axis of the electric machine within the rotor cavity. The rotor 140 defines a shaft receiver 150 that passes through the center of the rotor 140. The rotor 140 may receive a rotor shaft 160 that is disposed in the shaft receiver 150 of the rotor 140. The rotor shaft 160 is disposed about and rotates about the central longitudinal axis of the electric machine 100. The rotor 140 is mechanically coupled to the rotor shaft 160 such that the rotor 140 rotates the rotor shaft 160 within the rotor cavity or is rotated in response to rotation of the rotor shaft 160 within the rotor cavity. The rotor 140 is physically spaced apart from the stator 120 with a rotor gap (not explicitly shown) defined between the stator 120 and the rotor 140 such that rotation of the rotor 140 within the rotor cavity is without physical obstruction from the stator 120.

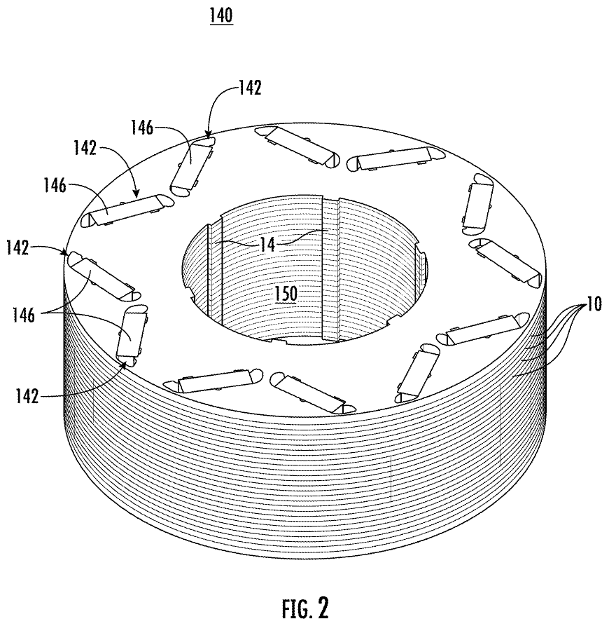

With additional reference to FIG. 2, the rotor 140 is illustrated in accordance with embodiments of the present disclosure. The rotor 140 is formed of a plurality of laminations or layers 10 that are stacked with one another to form the rotor 140.

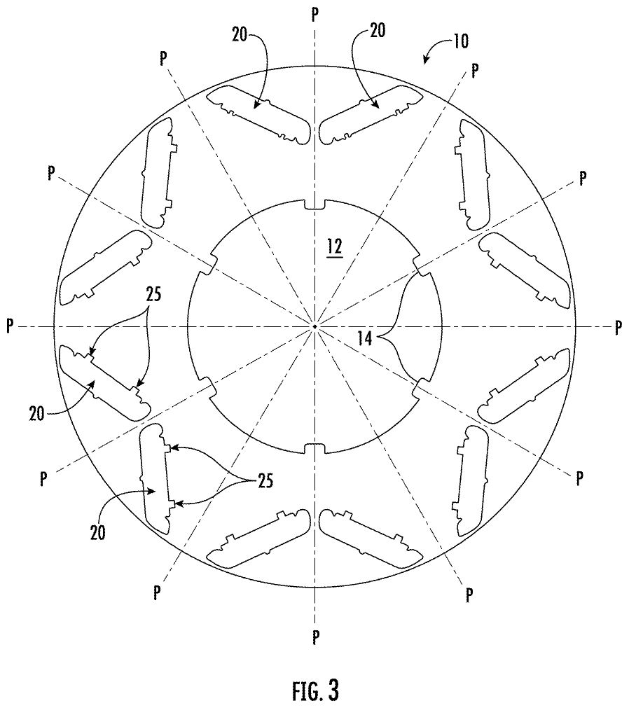

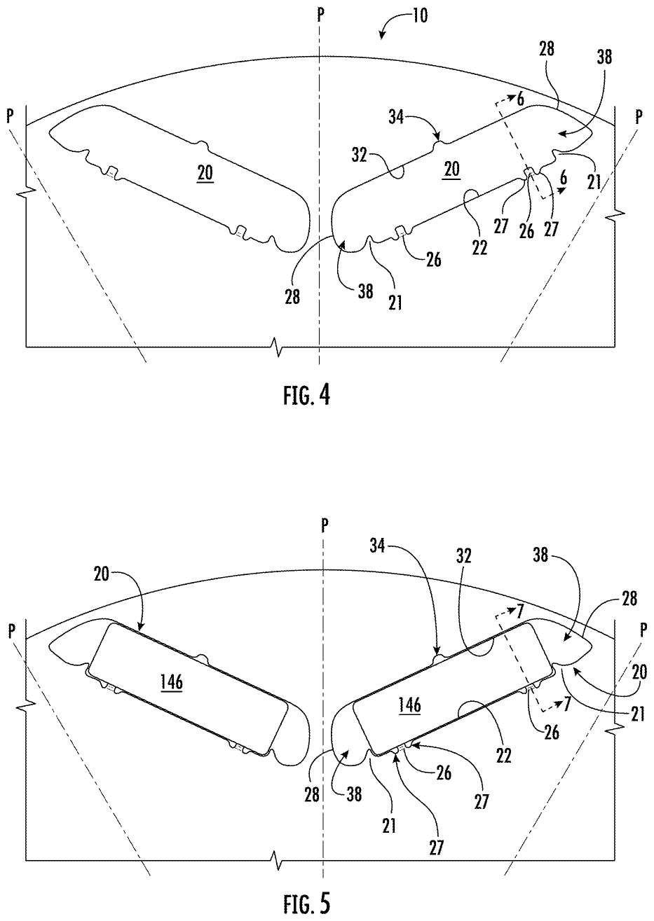

Referring now to FIGS. 3 and 4, a layer 10 of the rotor 140 is illustrated in accordance with embodiments present disclosure. Each layer 10 of the rotor 140 may be substantially similar to the other layers 10 of the rotor 140. As such, only a single layer 10 will be detailed herein for reasons of brevity. The layer 10 may be substantially circular in cross-section. The layer 10 may be thick enough such that individual features of each layer 10 may have some rigidity but be flexible as detailed below. In embodiments, each layer may have a thickness in a range of 0.1 mm to 5.0 mm, e.g., 0.1 mm to 2.0 mm. As shown, the layer 10 is for a twelve-pole rotor. In some embodiments, the layer 10 may be for a two-pole, four-pole, six-pole, eight-pole, ten-pole, fourteen-pole, sixteen-pole, eighteen-pole, twenty-pole, twenty-two-pole, or twenty-four-pole rotor. In particular embodiments, the rotor 140 may have an odd number of poles such that the layer 10 may be for a three-pole, five-pole, seven-pole, nine-pole, eleven-pole, thirteen-pole, fifteen-pole, seventeen-pole, nineteen-pole, twenty-one-pole, or twenty-three-pole rotor. In certain embodiments, the layer 10 may be for a rotor having more than twenty-four poles.

The layer 10 includes a shaft opening 12 defined therethrough. The shaft opening 12 is centered about a central longitudinal axis of the layer 10 such that the layer 10 rotates about the central longitudinal axis. The shaft openings 12 of the plurality of layers 10 are aligned to form the shaft receiver 150. The layer 10 includes one or more shaft engagement keys 14 that extend inward into the shaft opening 12. The shaft engagement keys 14 are configured to be received in keyways 162 defined in an outer surface of the rotor shaft 160 (FIG. 1) to rotatably fix the layer 10, and thus the rotor 140, to the rotor shaft 160. The shaft engagement keys 14 may be equally spaced about the perimeter of the shaft opening 12. In some embodiments, the shaft engagement keys 14 are unequally spaced about the perimeter of the shaft opening 12 to rotationally align or clock the layer 10 with the rotor shaft 160. In certain embodiments, the layer 10 defines engagement keyways, in addition to or in place of the shaft engagement keys 14, that receive rotor keys of the rotor shaft 160 to rotatably fix the layer 10 to the rotor shaft 160. The keys and keyways may rotatably align the rotor shaft 160 with the rotor 140. In some embodiments, each layer 10 or the rotor 140 may be provided without keys or keyways with each layer 10 or the rotor 140 as a whole secured to the shaft 12 with an interference fit. In certain embodiments, with keys and keyways, each layer 10 or the rotor 140 as a whole may be partially secured to the shaft 12 via an interference fit.

The layer 10 defines magnet openings 20 that are radially spaced about the layer 10. Each layer may be radially and/or rotationally symmetrical with one another. The layer 10 may include one or more magnet openings 20 positioned at or adjacent to each pole of the layer 10. As shown, there are two magnet openings 20 adjacent each pole of the layer 10 such that there are twelve magnet openings 20 disposed about the circumference of the layer 10. As shown, the magnet openings 20 are disposed at angles relative to radial lines P extending from the center of the layer 10 through a pole of the layer 10. As shown, the magnet openings 20 are offset from the radial lines P. In certain embodiments, the magnet openings 20 are disposed at an angle in a range of 15 degrees to 45 degrees, e.g., 30 degrees, from a line perpendicular to a radial line P. It will be appreciated that a pole of radial line P is the pole of the magnets adjacent the radial line P with the polarity of the poles alternating about the rotor 140. The magnet openings 20 of the plurality of layers 10 are aligned with one another to form magnet channels 142 of the rotor 140 (FIG. 2).

Each magnet opening 20 is defined by an inner radial wall 22 and an outer radial wall 32 that is disposed substantially radially outward from the inner radial wall 22. As shown, the inner radial wall 22 and the outer radial wall 32 are linear and parallel to one another. However, in some embodiments, the inner radial wall 22 and/or the outer radial wall 32 may be arcuate. In such embodiments, a magnet secured within a magnet opening 20 with an arcuate inner radial wall 22 or outer radial wall 32 may be shaped to engage the arcuate wall. In some embodiments, the curvature of an arcuate inner radial wall 22 or arcuate outer radial wall 32 may correspond to a radius of the rotor 140 at the position of the respective wall.

The ends of each magnetic opening 20 are defined by end walls 28 that extend between the inner radial wall 22 and the outer radial wall 32. The end walls 28 may be substantially linear and extend outward from the inner radial wall 22 to the outer radial wall 32 at an angle less than 90 degrees from the inner radial wall 22 such that the outer radial wall 32 has a length less than the inner radial wall 22. The angle of the end walls 28 relative to the inner radial wall 22 may be the same as one another such that the magnet opening 20 substantially forms a trapezoidal shape. In certain embodiments, the angle of the end walls 28 are different from one another. The end walls 28 may be arcuate or include rounded transitions to the inner radial wall 22 and/or the outer radial wall 32. One of the end walls 28 may be disposed adjacent the radial line P such that a pole is defined between the end wall 28 and an end wall of an adjacent magnet opening 20. The other of the end walls 28 may be disposed adjacent an outer peripheral edge of the layer 10.

The inner radial wall 22 includes one or more retention tabs 26 that extend from the inner radial wall 22 towards the outer radial wall 32. As described in greater detail below, the retention tabs 26 are configured to engage a magnet 146 received in the magnet opening 20 and urge the magnet 146 towards the outer radial wall 32. The retention tabs 26 may be prebent downward to aid in receipt of a magnet 146 into the magnet opening 20. The retention tabs 26 may be prebent from the plane of the respective layer 10 at an angle a range of 10 degrees to 60 degrees, e.g., 15, 30, or 45 degrees. When the retention tabs 26 are prebent, the retention tabs 26 are out of plane with the rest of the respective layer 10. The downward direction in which the retention tabs 26 may be the bottom of the layer 10 when stamped. Prebending the retention tabs 26 downward may reduce damage to a magnet 146 as the magnet 146 is received in the magnet opening 20. Prebending the retention tabs 26 may prevent a burr on the bottom of the layer 10 from engaging a surface of the magnet 146. As shown, the layer 10 includes retention tabs 26 in the magnet openings 20 of a single pole of the layer 10 such that the other magnet openings 20 do not include retention tabs 26. In some embodiments, the other magnet openings 20 define tab recess 25 (FIG. 6) that are sized and dimensioned to receive a portion of retention tabs 26 of other layers 10 as detailed below. In such embodiments, the layers 10 may be clocked or rotated by a pole or a pair of poles in the stack of the rotor 140 such that the retention tabs 26 of one layer 10 are received in the tab recesses 25 of the layers 10 below the layer 10 including the retention tabs 26.

The retention tabs 26 may extend from a point inward of the inner radial wall 22 with a relief cutout 27 defined in the inner radial wall 22 on either side of the inner retention tab 26. The relief cutout 27 may allow the retention tabs 26 to bend downward without bending the remainder of the inner radial wall 22. Extending the retention tabs 26 from a point inward of the inner radial wall 22 may reduce a space between a magnet 146 received in the magnet opening 20 and the inner radial wall 22 and/or allow the magnet 146 to be in substantial contact with inner radial wall 22. Reducing a space between the magnet 146 and the inner radial wall 22 may increase a magnetic flux in the rotor 140 formed of the layers 10. When the retention tabs 26 are bent by engagement with the magnet 146, the retention tabs 26 may be self-biased towards the plane of the respective layer 10 to retain the magnet 146 within the respective magnet channel. As shown, the tabs 26 are rectangular in shape; however, the tabs 26 may have a variety of shapes including triangular or have an end edge that is non-parallel to the opposite wall, e.g., the outer radial wall 32. In some embodiments, the tabs 26 may be trapezoidal or semicircular in shape.

The inner radial wall 22 may include magnet stops 21 that extend from the inner radial wall 22 towards the outer radial wall 32. The magnet stops 21 may be configured to retain the ends of a magnet received in the magnet opening 20 such that the magnet is prevented from translating within the magnet opening 20. In some embodiments, the end walls 28 may engage the ends of the magnet 146 to secure the magnet 146 within the magnet opening 20. An air gap 38 may be defined between the magnet stops 21 and the end walls 28. The layer 10 may include magnet stops 21 in each of the magnet openings 20 or may include the magnet stops 21 only in magnet openings 20 at a single pole similar to the retention tabs 26. In some embodiments, the air gap 38 may be filled with a filler material. The filler material may be a polymer such as a thermoset or thermoplastic polymer.

The outer radial wall 32 may define a channel 34 that extends outward from the outer radial wall 32. The channel 34 may be positioned at a midpoint along the outer radial wall 32. The outer radial wall 32 may define multiple channels 34. In some embodiments, the inner radial wall 22 may include a channel similar to the channel 34.

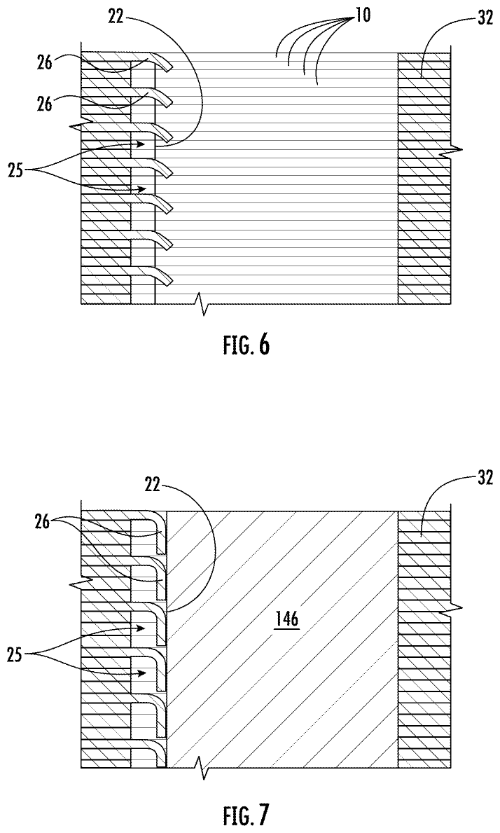

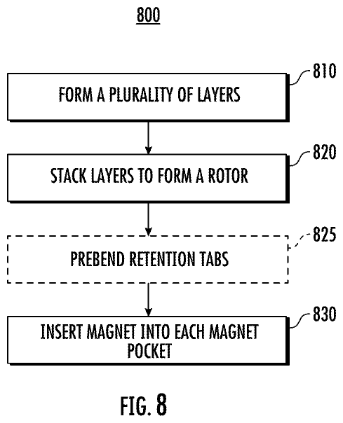

Referring now to FIG. 8, a method for manufacturing a rotor is described in accordance with the present disclosure with reference to the rotor of FIGS. 2-7 and is generally referred to as method 800. The method 800 may include forming a plurality of layers or laminations 10 (Step 810). Forming the plurality of layers 10 may include a progressive stamping process in which one or more dies are used to shape and/or remove material from the layers 10 until the layers 10 have a desired shape and include desired features. Stamping the plurality of layers 10 may include each layer 10 being substantially the same as the other layers 10. In some embodiments, stamping the plurality of layers 10 may include prebending retention tabs 26 of each layer of the plurality of layers 10 during the forming process. The forming process includes creating a plurality of magnet openings 20 in each layer 10. The plurality of magnet openings 20 may be punched out of each layer 10. The retention tabs 26 may be prebent during or after the punching out of the magnet openings 20. In some embodiments, the retention tabs 26 may be prebent by passing a tool or die into or through the magnet openings during the stamping process. In certain embodiments, the magnet openings 20 may be punched out and the retention tabs 26 may be prebent with a single die. Forming and/or prebending the retention tabs 26 during the stamping process may all for precise control of the shape of the retention tabs 26.

With plurality of layers 10 formed, the layers are stacked relative to one another about a central longitudinal axis of the rotor 140 (Step 820). As the layers 10 are stacked with one another, each layer 10 may be rotated or clocked a predetermined number of poles in relation to the previous layer. For example, each layer 10 may be rotated by a single pole with the previous layer 10. Rotating each layer 10 may allow for each magnet channel 142 of the rotor 140 to have a number of retention tabs 26 positioned in the magnet channel 142 when less than every magnet opening 20 includes retention tabs 26. For example, as shown, the rotor 140 is a twelve-pole rotor with only a pair of magnet openings disposed about a single pole of each layer 10 including retention tabs 26 in the magnet openings 20 thereof such that the rotor 140 includes retention tabs 26 in every sixth layer 10. In some embodiments, the retention tabs by be aligned as a function of the number of poles of the rotor. The layers 10 are stacked until the rotor 140 has a predetermined thickness. In some embodiments, the rotor 140 may have a thickness in a range of 25 mm to 250 mm, e.g., 30, 35, 40, 45, 50, 55, 60, 65, 70, 75, 78, 80, 85, 90, 95, 100, 105, 110, 115, 120, 125, 130, 135, 140, 145, or 150 mm.

With the rotor 140 formed, magnets 146 are inserted in the magnet channels 142 of the rotor 140 (Step 830). As the magnets 146 are inserted into the magnet channels 142, the magnets 146 contact the retention tabs 26 of the magnet channel 142 such that magnets 146 are urged away from the retention tabs 26 towards the opposite wall defining the magnet channel 142 such that the magnet 146 is mechanically retained within the magnet channel 142. As the magnet 146 is inserted into the magnet channel 142, engagement of the magnet 146 with the retention tabs 26 may bend the retention tabs 26.

In some embodiments, the retention tabs 26 may be prebent before insertion of the magnet 146 (Step 825). As noted above, the retention tabs 26 may be prebent during the stamping process. In some embodiments, the retention tabs 26 may be prebent after formation of the rotor 140. For example, a die or bar may be inserted into the magnet opening 20 or magnet channel 142 before the magnet 146 such that the die engages and bends the retention tabs 26 downward before the insertion of the magnet 146. The die may have a width less than the width of the magnet 146 such that the die prebends but does not fully bend the retention tabs 26 such that the retention tab 26 prebent. Prebending the retention tabs 26 may reduce damage to the magnets 146 during insertion of the magnets 146 into the rotor 140. The retention tabs 26 may be prebent in a direction such that a burr from a stamping process is moved away from engagement with the magnet 146.

Although the method steps are described in a specific order, it should be understood that other steps may be performed in between described steps, described steps may be adjusted so that they occur at slightly different times, or the described steps may occur in any order unless otherwise specified.

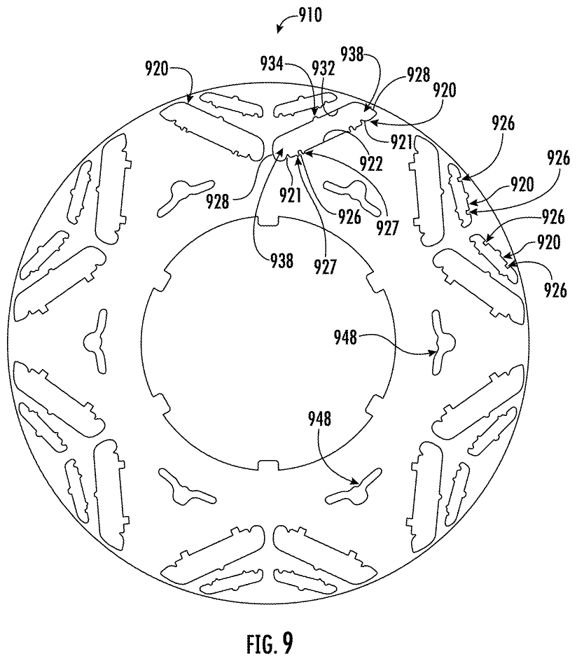

With reference to FIG. 9, a layer 910 is provided in accordance with the present disclosure. The layer 910 may be used to form a rotor similar to the rotor 140 detailed above. The layer 910 may be similar to the layer 10 with like elements represented with similar labels with a “9” preceding the previous label with only the differences described for reasons of brevity.

The layer 910 includes retention tabs 926 that extend from the outer radial wall 932 towards the inner radial wall 922. In some embodiments, a single magnet opening 920 includes retention tabs 926 that extend from both the inner radial wall 922 and the outer radial wall 932. In certain embodiments, the retention tabs 926 of the outer radial wall 932 are offset from the retention tabs 926 of the inner radial wall 922. In particular embodiments, the retention tabs of the outer radial wall 932 are aligned or oppose the retention tabs 926 of the inner radial wall 922. In particular embodiments, one or more magnet openings 920 of a layer 910 may include retention tabs 926 that extend only from the inner radial wall 922 thereof and one or more other magnet openings 920 may include retention tabs 926 that extend only from the outer radial wall 922.

As shown, the layer 910 includes two series of magnet openings 920 positioned at each pole of the layer 910. The magnet openings 920 are arranged in a first or inner series 912 of magnet openings 920 and the second or outer series 914 of magnet openings 920. The inner and outer series 912, 914 may be arranged such that the magnet openings 920 cooperate to form the poles of the rotor. Multiple series of magnet openings 920 may improve or increase a magnetic flux of a rotor formed of layers with multiple series of magnet openings 920.

The layer 910 may include a number of barrier openings 948 disposed about the rotor. The barrier openings 948 may be aligned with a pole that is defined by ends of the magnets 946 adjacent an outer circumferential edge of the layer 910. The barrier openings 948 may define an air gap. The barrier openings 948 may define air channels through the rotor which allows for other fluids to pass through the rotor.

As described above, rotors formed of the layers 10, 910 include layers 10, 910 that are the same and rotated or clocked relative to one another as stacked. However, in some embodiments, a rotor may be formed of a stack of layers that are different from one another. Such embodiments may allow for retention tabs having a length greater than a length of retention tabs when every pole/2 another retention tab is present, e.g., for a 12-pole rotor every 6 layers. In certain embodiments, a rotor may be formed of two different stampings. Such a rotor may have a first stamping in which the magnet openings define tab recesses at each pole and a second stamping that includes one or more retention tabs extending into each magnet opening. The rotor may be formed of a number of the first stampings with a second stamping included at every predetermined number of layers. For example, a second stamping could be included every twelfth layer which would allow for a longer retention tab to be used as the retention tab could extend through the tab recesses of eleven layers without interfering with another retention tab.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements, or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., XY, XZ, YZ, or XYZ). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the scope of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed:

1. A rotor for an electric machine, the rotor comprising:
a plurality of layers forming a stack of layers, each layer of the plurality of layers defining a plurality of magnet openings therethrough, the plurality of magnet openings aligned to form a plurality of magnet channels that extend through the rotor, each magnet opening defined by an inner radial wall and an outer radial wall, the inner radial wall of at least one of the magnet openings of each layer including an inner retention tab that extends towards the respective outer radial wall; and
a magnet received in each magnet channel, each magnet engaged with the inner retention tabs of multiple layers such that the magnet is mechanically retained in the respective magnet channel.

2. The rotor according to claim 1, wherein one or more of the inner radial walls or the outer radial walls include a magnet stop that extends towards the opposite wall, the magnet stop configured to prevent a magnet passing through the magnet opening from translating within the magnet opening.

3. The rotor according to claim 2, wherein an air channel of the magnet channel is disposed beyond the magnet stops when the magnet is received in the magnet channel.

4. The rotor according to claim 1, wherein the outer radial wall of at least one magnet opening of the plurality of magnet openings of each layer includes an outer retention tab that extend towards the respective inner radial wall, the outer retention tab is configured to engage a magnet that passes through the magnet opening to mechanically retain the magnet in a respective magnet channel.

5. The rotor according to claim 1, wherein the inner retention tab extends from a point inner of the respective inner radial wall with a relief opening defined on either side of the inner retention tab.

6. The rotor according to claim 1, wherein the magnet is engaged with the inner radial walls defining the respective magnet channel receiving the magnet.

7. The rotor according to claim 1, wherein each layer of the plurality of layers includes the inner retention tab in magnet openings adjacent a single pole of the respective layer.

8. The rotor according to claim 7, wherein the remaining magnet openings of each layer of the plurality of layers define tab recesses that are configured to receive the inner retention tab of other layers.

9. The rotor according to claim 7, wherein each layer of the plurality of layers is rotated by one or more poles from the previous layer such that the inner retention tabs are aligned at a predetermined number of layers, the predetermined number of layers being a function of the number of poles of the rotor.

10. An electric machine comprising:
a stator defining a rotor cavity; and
a rotor according to claim 1 rotatably disposed within the rotor cavity of the stator.

11. A rotor for an electric machine, the rotor comprising:
a plurality of layers forming a stack of layers, each layer of the stack of layers defining a plurality of magnet openings disposed radially about the respective layer, the magnet openings of each layer aligned with the magnet openings of the other layers of the plurality of layers to define a plurality of magnet channels that extend through the rotor, each magnet opening defined by an inner radial wall and an outer radial wall opposite the inner radial wall, the plurality of magnet openings including a first magnet opening, the inner radial wall of the first magnet opening including a retention tab that extends towards the outer radial wall; and
a magnet received in a respective magnet channel, the magnet engaging retention tabs of respective layers such the magnet is mechanically retained in the respective magnet channel.

12. The rotor according to claim 11, wherein the plurality of layers includes a first layer, a second layer in contact with the first layer, and a third layer in contact with the second layer such that the second layer is disposed between the first layer and the third layer, the first magnet opening of the first layer disposed adjacent a first magnetic pole of the rotor, the first magnet opening of the second layer disposed adjacent a second magnetic pole of the rotor, and the first magnet opening of the third layer disposed adjacent a third magnetic pole of the rotor, the first, second, and third magnetic poles disposed radially about the rotor from one another.

13. The rotor according to claim 11, wherein the plurality of layers includes a first layer, a second layer in contact with the first layer, and a third layer in contact with the second layer such that the second layer is disposed between the first layer and the third layer, the second layer rotated relative to the first layer such that the first magnet opening of the second layer is out of alignment with the first magnet opening of the first layer, the third layer rotated relative to the second layer such that the first magnet opening of the third layer is out of alignment with the first magnet opening of the first layer and the first magnet opening of the second layer.

14. The rotor according to claim 11, wherein engagement of the retention tabs of the respective layers with the magnet bends the retention tabs of the respective layers out of plane with the rest of the respective layer of the retention tab.

15. The rotor according to claim 14, wherein the retention tabs are self-biased towards the plane of the respective layer of the respective retention tab when engaged with the magnet.

16. The rotor according to claim 14, wherein the retention tabs are prebent out of plane with the rest of the respective layer of the respective retention tab.

17. The rotor according to claim 11, wherein each layer of the plurality of layers has a thickness in a range of 0.1 millimeters to 2.0 millimeters.

18. The rotor according to claim 11, wherein the magnet is in contact with the inner radial wall of the plurality of layers defining the respective magnet channel.

19. A method of manufacturing a rotor for an electric machine, the method comprising:
forming a plurality of layers with each layer defining a plurality of magnet openings disposed about the respective layer, the plurality of magnet openings including a first magnet opening, the first magnet opening including a retention tab extending into the magnet opening;
stacking the plurality of layers with each layer rotated relative to the previous layer such that the first magnet opening is rotationally offset from the first magnet opening of the previous layer; and
inserting a magnet into a magnet channel defined by magnet openings of the plurality of layers such that the magnet is mechanically fixed in the magnet channel by engagement of the magnet with retention tabs.

20. The method according to claim 19, further comprising prebending the retention tab such that the retention tab is out of plane with the rest of the respective layer before inserting the magnet into the magnet channel.
